(19) United States
(12) Patent Application Publication
(10) Pub. No.: US 2010/0305809 A1
(43) Pub. Date: Dec. 2, 2010

(54) DEVICE FOR RECEIVING SIGNALS FROM SENSORS ASSOCIATED WITH VEHICLES COMPONENTS, PARTICULARLY TIRES, AND SYSTEM COMPRISING THE SAME

(76) Inventors: Giorgio Audisio, Milano (IT); Federico Mancosu, Milano (IT); Fabio Mariani, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/809,026

(22) PCT Filed: Dec. 19, 2007
(86) PCT No.: PCT/EP2007/064249

§ 371 Date: Jun. 17, 2010

(51) Int. Cl. B60C 23/00

(52) U.S. Cl. 701/33

(57) ABSTRACT

A device includes: a wireless receiver unit adapted to receive signals from at least one sensor mounted on a vehicle, wherein the signals received from the at least one sensor carry data related to operating parameters of at least one vehicle's component, detected by the at least one sensor; an interface adapted to the coupling of the device to a peripherals connection port of a vehicle's data processing system integrated in the vehicle, the peripherals connection port being accessible to users within the vehicle's cabin for the connection of peripheral type electronic devices. The device, when coupled to the peripherals connection port of the vehicle's data processing system, is operable to transfer thereto the data related to vehicle's operating parameters detected by the at least one sensor and to enable the vehicle's data processing system to process the transferred data for the interpretation of the operating parameters.

### BACKGROUND OF THE INVENTION

The present invention generally relates to the field of automotive, and particularly to electronic systems for monitoring the operating conditions of various types of vehicles' components, in particular of vehicles' tires, generally known as Tire Monitoring Systems (TMSs), such as for example systems for monitoring the tires' pressure (Tire Pressure Monitoring Systems or TPMSs). More specifically, the present invention relates to a device for receiving signals from sensors associated with a vehicle's components, and to a system comprising such device.

### DESCRIPTION OF THE RELATED ART

In the automotive field, systems for monitoring the operating conditions of various types of vehicles' components are known.

In particular, systems for monitoring the operating conditions of vehicles' tires (TMSs), like TPMSs which allow monitoring the pressure of the vehicles' tires, are expected to gain popularity, because they contribute to increasing the active and passive safety.

TPMSs are electronic systems designed to monitor the operating conditions, particularly the pressure and other operating parameters of vehicles' tires.

Generally, a TPMS comprises one or more sensor units, intended to be operatively associated with one or more tires of a vehicle (being for example placed within the tire, or on the inflating valve thereof), which are adapted to measure tire operating parameters, basically the tire pressure; some sensors may also be adapted to measure the tire's temperature, and more sophisticated TMSs exploit sensors units capable of measuring other parameters, like the number of revolutions of the tire, the vertical load, the actual friction, etc.

The sensor units transmit, typically by means of wireless Radio Frequency (RF) transmission, data relating to the measured tire parameters values to a receiver unit, intended to be placed inside the vehicle cabin. The receiver unit is capable of receiving the data transmitted by the sensor units, and of processing the received data to, e.g., display relevant indications to the vehicle's driver, and particularly to issue alarms when, for example, the pressure or the temperature of one or more tires is out of a predetermined safety range.

WO 2005/116603 discloses a universal receiver (OTR) device which functions within a vehicle in the ‘under-the-hood’ (UTH) environment such that various types of tire pressure management system (TPMS) device, located within, upon or near a vehicle's tires can transmit tire information, such as the transmitter identification number (TIN), the tire unique identifier (TUID), the vehicle identification number (VIN), tire pressure, tire temperature, tire rotation, and other tire relevant data, to the OTR for further processing regardless of frequency, data transfer speed, or data format of the TPMS device. The OTR device in sequence: identifies the TPMS device, receives the tire information from the TPMS device, and processes the tire information into date records for efficient and optimized transmission of such data records for future analysis both within and off a vehicle. The OTR also interfaces with various types of telematics devices, regardless of the type of transmission or protocol used, by identifying the type of telematics device. The OTR also stores or retrieves information related to various telematics and TPMS devices in order to identify these devices. For example, an automotive manufacturer, dealership, or tire distributor would be able to select various manufacturers' TPMS and telematics devices for installation within the vehicle and with the OTR collect previously captured TPMS data for further analysis.

In US 2006/087419 a tire safety monitoring GPS display device is disclosed that includes a contact surface of a sensor joined to a tire steel ring by means of a circular fitting fixing agent, and the sensor is fixed onto the tire steel ring hereof. When the sensor circuit interior of the sensor detects internal status of a tire, the transmitting circuit transmits data to an aerial, and further transmits to a main receiver, whereupon status regarding interior of the tire is displayed on a screen of the main receiver. If an anomaly occurs, a communications module transmits a signal to the GPS receiver, at which time displaying on a monitor a car repair workshop at a closest distance from vehicle. Furthermore, if unusual movement in position of the vehicle occurs, the sensor transmits data to the GPS receiver thereby notifying location of the vehicle to a mobile communications device used by a user.

### SUMMARY OF THE INVENTION

The Applicant observed that the commercial success of TMSs, and more generally monitoring systems of any kind of vehicles' components, that are sold as after-market vehicles'accessories, to be mounted on vehicles that do not include these monitoring systems as a part of the standard original vehicles' equipment, and/or are not integrated in the vehicle at the manufacturing stage, is significantly undermined by problems related to the monitoring systems installation.

Mounting an after-market vehicles' component monitoring system on a vehicle may be complicated, and generally poses problems.

In particular, the receiver unit of a TMS needs to be connected to a power supply line of the vehicle's electric system. Although taking the power supply from the cigarette-lighter socket, or from a power outlet generally provided for in the vehicle's cabin, may seem a straightforward solution, it is not satisfactory, because in this way these accessories could not be used for other purposes. Thus, it is almost always necessary to manipulate the vehicle's electric system. This operation is often not easy, so that the installation of the TMS has to be entrusted to technically-qualified people. However, even in this case problems may arise from the viewpoint of the warranty offered by the manufacturer on the vehicle, which may condition the persistence of the warranty to the fact that any intervention on the vehicle is entrusted to affiliate service centers.

Also, an after-market TMS receiver unit is necessarily designed as a stand-alone unit, with all the information processing resources and man/machine interfaces (audio/visual indicators, display devices, buttons or keyboards) necessary for its operation; indeed, it is practically impossible to take advantage of the already existing vehicle's equipment (normally available on the vehicle's dashboard), because the receiver unit cannot interface with any existing vehicle's instruments.

Difficulties often arise also in connection with the placement of the receiver unit within the vehicle, e.g. on the dashboard; problems of available space limit the number of possible locations for the receiver unit placement, and the final result is generally scarcely satisfactory even from the aesthetic viewpoint, because the receiver unit is perceived by people as a “foreign body” not integrated with the rest of the vehicle's equipment.

The Applicant has tackled the problem of providing a vehicles' components monitoring system, particularly but not limitatively a TMS that, even if sold as an after-market accessory to be installed on already circulating vehicles, is less affected by the problems outlined in the foregoing.

The Applicant has observed that modern vehicles are often provided with standard interfaces that allow an easy and reliable connectivity of various kinds of peripheral consumer electronics devices (like for example mobile phones, MP3 players, GPS navigation tools, USB storage devices—“pen drives”) with a vehicle's data processing system, having input/output interfaces, which is embedded in the vehicle at the manufacturing stage and interacts with man/machine interfaces like a display, buttons, the loudspeakers of the vehicle's Hi-Fi radio-CD system. The vehicle's data processing system is capable of acting as a host for such peripheral devices when the latter are connected thereto through the standard interfaces; for example, the vehicle's display may be used by an external navigation tool to display the navigation information to the driver, or an MP3 player may exploit the vehicle stereo system to play music or MP3 audio files may be downloaded from the MP3 player to the vehicle's data processing system for being played directly by the vehicle's Hi-Fi system.

The Applicant has found that the data processing system embedded in a vehicle by the vehicle manufacturer, thanks to the capability it offers of interfacing to peripheral devices through standard interfaces, can be exploited as a host data processing system for a vehicles' components monitoring system, like a TMS or a TPMS, so as to perform computing-intensive functions like processing the data transmitted by the sensors associated with the vehicle's components, for example tires' sensors, and the audio/visual display devices already integrated in the vehicle's accessory equipment can be advantageously exploited for displaying relevant indications about the vehicle's components operating conditions to the vehicle's driver.

The Applicant has also found that a standard interface made available by a vehicle's data processing system could be advantageously exploited for connecting a wireless receiver being able of performing substantially only the reception of the signals coming from the sensors of the monitoring system, leaving complex calculations and/or displaying functions to the vehicle's data processing system.

According to an aspect of the present invention, a device is provided comprising:
a wireless receiver unit adapted to receive signals from at least one sensor mounted on a vehicle, wherein the signals received from the at least one sensor carry data related to operating parameters of at least one vehicle's component, detected by the at least one sensor;
an interface adapted to the coupling of the device to a peripherals connection port of a vehicle's data processing system integrated in the vehicle, said peripherals connection port being accessible to users within the vehicle's cab for the connection of peripheral type electronic devices;

and wherein the device, when coupled to the peripherals connection port of the vehicle's data processing system, is operable to transfer thereto the data related to vehicle's operating parameters detected by the at least one sensor and to enable the vehicle's data processing system to processing the transferred data for the interpretation of the operating parameters.

Preferably, the device may comprise a power supply unit adapted to exploit a power supply provided by the vehicle's data processing system through said connection port thereof for generating a power supply for the operation of the device. This allows avoiding complex connections to the vehicle's electric system.

The device may comprise a repository of at least one software package adapted to be installed on and executed by the vehicle's data processing system for said processing of the data related to vehicle's operating parameters detected by the at least one sensor, and the device may be adapted to upload said at least one software package to the vehicle's data processing system when coupled to the peripheral's connection port thereof. A facilitated and user-friendly procedure can thus be used for enabling the vehicle's data processing system to perform the processing of data detected by the sensors.

Said repository may be adapted to store a library of software packages adapted to be installed on and executed by the vehicle's data processing system for said processing of the data related to vehicle's operating parameters detected by the at least one sensor, each software package of said library corresponding to a respective type of sensor.

The device may include a processing unit adapted to identify in said library a software package corresponding to a specific type of sensor mounted on the vehicle, and to upload to the vehicle's data processing system the identified software package. This simplified procedure also facilitates the user.

The device may include a processing unit adapted to download said at least one software package from a software package storage and to store it in said repository.

Said software package storage may include a memory card, and the device may comprise a memory card connection interface adapted to the plugging of the memory card wherein said at least one software package to be downloaded is stored. The memory card could be sold with the at least one software package already stored therein, or the at least one software package could be downloaded on the memory card from a suitable network connection (e.g. from the Internet).

The processing unit of the device may be adapted to download said at least one software package from said software package storage by connection of said interface to a peripheral connection port of the software package storage. This procedure also facilitates the user.

The device may further comprise a connection interface having a peripherals connection port replicating the peripherals connection port of the vehicle's data processing system, and the device, when coupled to the peripherals connection port of the vehicle's data processing system, may be adapted to operate as a bridge between a peripheral device connected to said connection port of the connection interface and the vehicle's data processing system. This enables a user to connect and use another peripheral device even in presence of the device of the invention.

Said interface may include a USB interface or a Firewire interface adapted to the coupling of the device to a USB port or a Firewire port of the vehicle's data processing system.

Said at least one sensor may in particular include a tire's operating parameters sensor associated with at least one of the vehicle's tires. Said data related to vehicle's operating parameters detected by the at least one sensor may include one or more among a tire's inflating pressure, a tire's temperature, a tire's number of revolutions, a tire's friction coefficient, exerted forces at a tire-road interface, a tire's contact patch area length, a tire's slip angle, tire's aquaplaning conditions, road conditions and tire's tread band wear.

According to another aspect of the present invention, a vehicle's components operating conditions monitoring system is provided comprising:
at least one sensor unit adapted to be associated with a vehicle's component, the at least one sensor unit comprising at least one sensor adapted to detect vehicle's component operating parameters, and a wireless transmitter adapted to wirelessly transmit signals carrying data related to the vehicle's component operating parameters detected by the at least one sensor;
a wireless receiver unit according to the first aspect of the invention adapted to receive said signals from the at least one sensor unit.

### BRIEF DESCRIPTION OF THE DRAWINGS

These and further features and advantages of the present invention will be best understood by reading the following detailed description of some embodiments thereof, provided merely by way of non-limitative example, description that will be conducted making reference to the annexed drawings, wherein:

FIG. 1 schematically shows an overview of a TMS according to an embodiment of the present invention;

FIG. 2 schematically shows, in terms of functional blocks, the main components of a receiver unit of the TMS of FIG. 1, according to an embodiment of the present invention;

FIG. 3 is a simplified action flow showing the operation of the receiver unit according to an embodiment of the present invention; and

FIG. 4 pictorially shows a possible set-up for the downloading of software packages to the receiver unit.

### DETAILED DESCRIPTION OF SOME EMBODIMENTS OF THE INVENTION

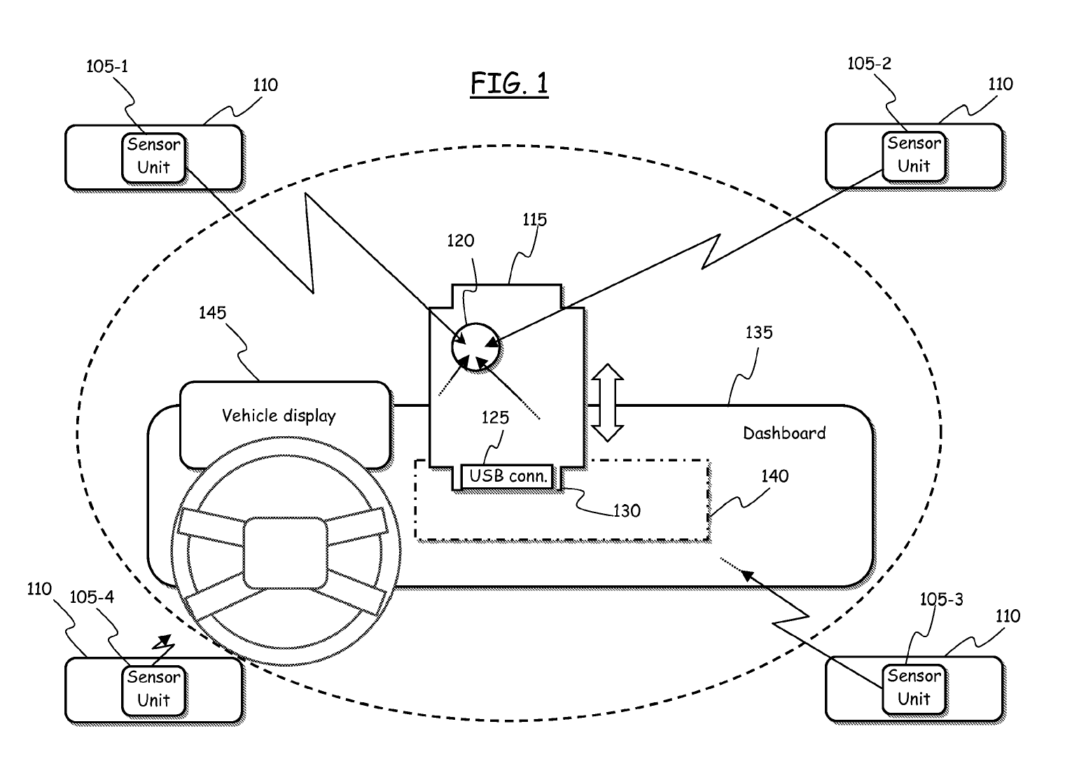

Making reference to FIG. 1, an overview of a TMS, particularly a TPMS according to an embodiment of the present invention is pictorially shown. The TPMS is intended to be mounted on a vehicle, like for example a car, and includes one or more sensor units, for example four sensor units 105-1, 105-2, 105-3 and 105-4, each one adapted to be operatively associated with a respective vehicle tire 110. The sensor units 105-1, 105-2, 105-3 and 105-4 may include sensors adapted to measure one or more tire operating parameters, like for example one or more parameters among the tire pressure, the tire temperature, the number of revolutions of the tire, the tire friction coefficient, exerted forces at tire-road interface, contact patch area length, slip angle, aquaplaning status, road conditions (e.g. dry, wet, presence of ice, presence of snow, etc.) and tire's tread band wear. The sensor units 105-1, 105-2, 105-3 and 105-4 may for example be adapted to be placed inside a tire, or to be coupled to the tire inflating valve or the cap thereof or they may even be embedded in the tire material.

It is pointed out that the number of sensor units, and their nature, particularly the type and number of operating parameters that the sensors are capable of measuring, are not limitative for the present invention.

Each sensor unit 105-1, 105-2, 105-3 and 105-4 includes a wireless transmitter, particularly an RF transmitter, adapted to wirelessly transmit signals containing data related to the values of the tire operating parameters measured by the respective sensor(s). For example, the sensor units may transmit at 433 MHz, which is one of the standard frequencies assigned to transmissions for Industrial, Scientific and Medical (ISM) purposes by Short-Range Devices (SRD) like TPMSs. The sensor units 105-1, 105-2, 105-3 and 105-4 may also include a wireless RF receiver (i.e., they include an RF transceiver), for wirelessly receiving signals carrying data useful for the sensor units' settings and configuration parameters.

Among the data carried by the signals that the generic sensor unit may transmit there may also be a unique identifier code of the tire, and/or an indication of which of the vehicle's tires the transmitted data relate to (a functionality referred to as “auto-location”).

The detailed structure of the generic sensor unit 105-1, 105-2, 105-3 and 105-4 is not shown nor will be described in further detail, being per se known and not essential for the understanding of, nor limitative for the present invention.

The TPMS comprises a receiver unit 115 according to an embodiment of the invention, comprising a wireless receiver 120, particularly an RF receiver, adapted to receive the signals transmitted by the sensor units 105-1, 105-2, 105-3 and 105-4. The wireless receiver 120 may be a wireless transceiver, and be adapted to transmit to the sensor units 105-1, 105-2, 105-3 and 105-4 signals the data useful for the sensor units' settings and configuration parameters.

The detailed structure of the receiver unit 115 according to an embodiment of the present invention will be described subsequently; the receiver unit 115 comprises at least limited data processing resources, and has a standard-type connector 125 adapted to enable the (removable) connection of the receiver unit 115 to a standard-type connection socket 130 provided for in the vehicle's accessory equipment, for example located on the vehicle's dashboard 135, for the connection of consumer electronic peripheral devices.

As mentioned before, modern vehicles are now often provided with standard interfaces that allow an easy and reliable connectivity of various kinds of consumer electronics peripheral devices (like for example mobile phones, MP3 players, GPS navigation tools, USB storage devices—“pen drives”) with a vehicle's data processing system 140, which is embedded in the vehicle at the manufacturing stage and interacts with man/machine interfaces like a display device 145, buttons, the loudspeakers of the vehicle's stereo radio-CD system. The vehicle's data processing system 140 acts as a host for such peripheral devices when the latter are connected thereto through the standard interfaces; for example, the vehicle's display 145 may be used by an external navigation tool to display the navigation information to the driver, or an MP3 player may exploit the vehicle stereo system to play music or MP3 audio files may be downloaded from the MP3 player to the vehicle's data processing system 140 for being played directly by the vehicle's stereo system.

These kinds of vehicle's data processing systems are often based on standard, open operating systems, like for example Microsoft's Windows Mobile for Automotive, which allow the installation and execution of software applications for specific, custom purposes, just like a normal personal computer.

The connector 125 of the receiver unit 115 may in particular be a USB (Universal Serial Bus) connector, preferably (albeit not limitatively) a USB-2.0 connector, adapted to connected to a corresponding USB connection socket 130 on the vehicle's dashboard 135.

An advantage of the USB is that a USB host may supply power to a USB peripheral device, which thus does not need to have an autonomous power source. In particular, using a USB connection, the receiver unit 115 may receive the power necessary for its operation from the vehicle's data processing system 140, without the necessity of equipping the receiver unit 115 with an internal battery, nor of connecting the receiver unit 115 to the vehicle's power supply (vehicle's battery). Other types of standard connections suitable to supply power to a peripheral device exist, such as for example the Firewire interface (defined in the IEEE standardization documents 1394 and 1394b)

However, it is pointed out that although the use of a standard connection capable of supplying power to a peripheral device attached thereto may be regarded as preferential, it is not to be intended as limitative to the present invention, which may in general be practiced exploiting any kind of standard connection known or available now or in the future that will be provided on the vehicles, either wired or wireless, either capable of supplying power to peripheral devices or not.

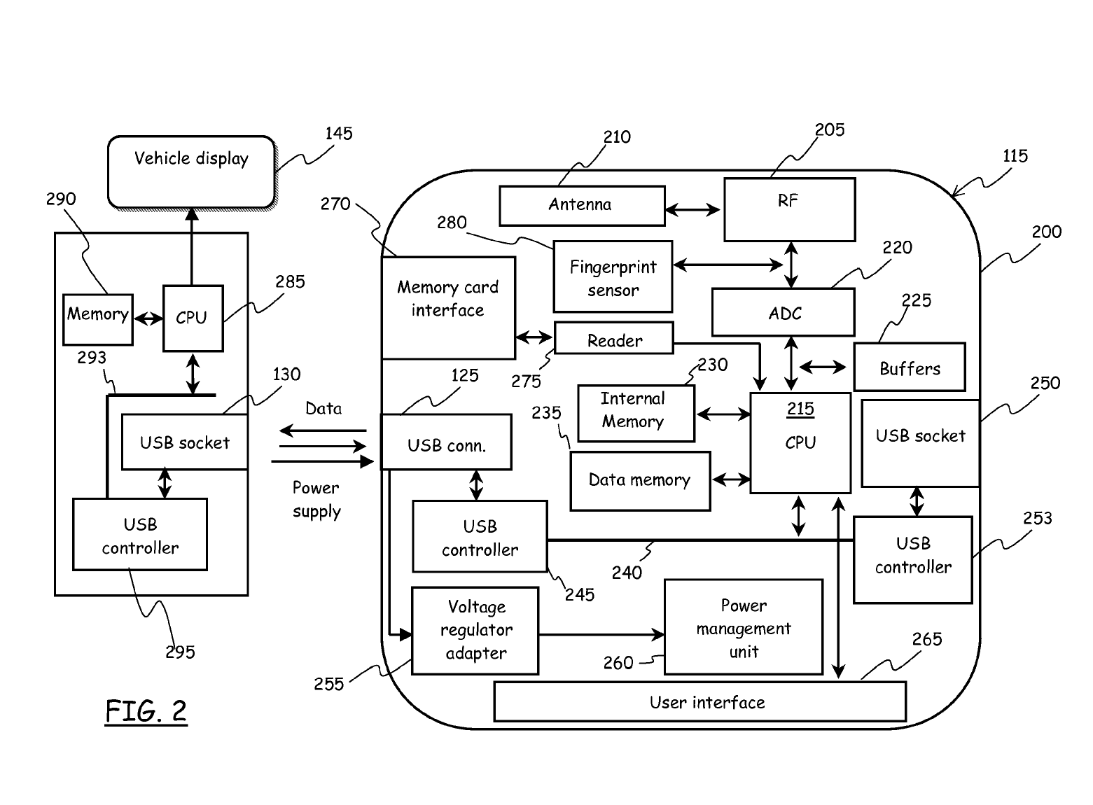

Referring now to FIG. 2, a more detailed scheme of a receiving unit 115 according to an embodiment of the present invention is shown, in terms of some of its functional blocks.

The receiving unit 115 comprises, within a casing 200, an RF section, schematically depicted as a block 205, which includes the wireless receiver or transceiver 120 shown in FIG. 1. In particular, the RF section 205 is intended to include a front-end for the coupling to an antenna 210, an RF receiver or transceiver, filters, adapters, demodulators, impedance-matching circuits and in general all the circuit elements necessary for wirelessly communication at radio frequency with the transmitters of the sensor units 105-1, 105-2, 105-3 and 105-4. The antenna 210 is for example an integrated, miniaturized, wide-band antenna, adapted to receive RF signals in a relatively wide frequency range, for example from a few hundreds of MHz to some GHz, so as to allow the reception from sensor units of different type and/or produced by different manufacturers.

The RF section 205 is connected to an input of a Central Processing Unit (CPU) 215; the connection of the RF section 205 to the CPU 215 may be mediated by an Analog-to-Digital Converter (ADC) 220, adapted to convert analog data (for example, measures of tire pressure and/or temperature values) received from the sensor units 105-1, 105-2, 105-3 and 105-4 into digital form; alternatively, the RF section 205 may be connected to an ADC input of the CPU 215. One or more buffers 225 may be provided to temporarily store the data received from the sensor units 105-1, 105-2, 105-3 and 105-4 waiting to be provided to the CPU; this may be useful in case the rate at which the data are received from the sensor units exceeds the rate at which the CPU 215 can handle the received data.

For its operation, the CPU 215 exploits memory resources, including in particular volatile (Read Only Memory—RAM) and non-volatile memory resources. The non-volatile memory resources may in particular include a non-volatile program memory (internal memory) 230, preferably of programmable type, for storing data like a firmware of the receiver unit 115, and a non-volatile data memory 235, for example a Flash memory, an Electrically Erasable and Programmable Read Only memory (EEPROM) for the storage of the proprietary software protocol necessary to interpret data transmitted from the sensors, as described in greater detail later on.

The CPU 215 is also connected, over a communication bus 240, to a USB controller 245, controlling the exchange of data through the USB connector 125; the receiver unit 115 preferably includes one or more USB sockets 250, connected to the bus 240 through a further USB controller 253, allowing the connection of other USB peripheral devices (not shown in the drawing), e.g., “pen drives”, MP3 music players, etc., to the USB interface of the vehicle's data processing system 140 also when the USB connector 125 of the receiving unit 115 is inserted into the vehicle's USB socket 130 (in other words, the receiving unit 115 is preferably also able to operate as a USB hub or bridge towards the vehicle's data processing unit).

A voltage adapter/regulator 255 is connected to the USB connector 125, particularly to electric terminals thereof which, when the connector 125 is plugged into the socket 130, receive the power supply from the USB connector 125. The USB comprises four bus lines, namely a voltage supply line, a reference potential or ground voltage line, and a pair of differential-voltage data lines. The USB host device supplies, on the voltage supply line, a USB voltage of nominally 5 V+/−0.25 V referred to the ground voltage line. The voltage adapter/regulator 255 receives the USB voltage and generates (possibly down-scaled, and/or boosted) regulated voltages suitable to supply the circuitry and components of the receiver unit 115; a down-scaling of the USB voltage may be necessary when one or more of the integrated circuit components of the receiver unit 115—like for example the CPU 215, and/or the RF section 205—require stabilized voltages of value different from the USB voltage. The regulated voltages are fed to a power management unit 260, which is adapted to manage a power-on reset procedure of the receiver unit 115, when it is powered after being plugged into a USB connector. The power management unit 260 is further adapted to manage power fail situations, when for example the receiver unit 115 is unplugged from a USB connector.

The receiver unit 115 may further include a user interface 265, for the interaction with the user; the management interface may comprise one or more LEDs (Light Emitting Diodes) for visually signalling particular conditions, one or more pushbuttons for triggering particular operations, like for example pushbuttons for causing the receiver unit 115 communicate with communications infrastructures present on the roads, like pay-toll gates on highways, as will be described later on, or with other vehicles.

Optionally, the receiver unit 115 may include a memory card interface 270, preferably a universal memory card interface, including a universal memory card socket and adapted to receive different types of memory cards like MMCs (MultiMedia Cards), SD (Secure Digital) cards, CF (CompactFlash) cards, MS (MemoryStick) cards, SM (SmartMedia) cards and the like. A memory card reader 275 coupled to the memory card interface 270 and to the CPU 215 is adapted to allow the interaction between the CPU 215 and a memory card inserted into the memory card interface 270.

Also, the receiver unit 115 may include biometric sensors, like for example a fingerprint sensor 280, for the detection of user's biometric parameters in order to identify the user.

The RF section may also include wireless communication interfaces different from that necessary for receiving data from the tires' sensor units, for example an IR (InfraRed) communication interface for the interaction with a remote control device (not shown in the drawing), and/or a Bluetooth interface, and/or a Wi-Fi and/or WiMax interface, for interacting with communications infrastructures external to the vehicle and installed on the roads, like for example pay-toll or control gates, or with other vehicles.

In FIG. 2 there is also schematically shown the structure of the vehicle's data processing system 140; essentially, it comprises a CPU 285, exploiting memory resources 290 (RAM, ROM) for its operation, and the CPU 285, through a bus 293, is connected to a USB controller 295 associated with the USB socket 130. The CPU 285 is coupled to the vehicle's display 145, and it may also be coupled to the vehicle's stereo system and/or to other warning systems integrated in the vehicle (not shown in the drawing).

In operation, the data memory 235 of the receiver unit 115 is used to store software modules to be downloaded to a host data processing system like the vehicle's data processing system 140. These software modules define the communication protocol to be used by the host data processing system for communicating with the receiver unit 115, and/or the procedures for processing and interpreting the data provided by the tires' sensor units. In particular, the processing procedures may include safety margins settings for the tires' operating parameters, definition of anomalous conditions, proprietary or standard software protocol and algorithms necessary to interpret the data transmitted by the tires' sensor units and the like. The processing and/or interpreting procedures may also be adapted for displaying the detected conditions to the user on the vehicle's data processing system display.

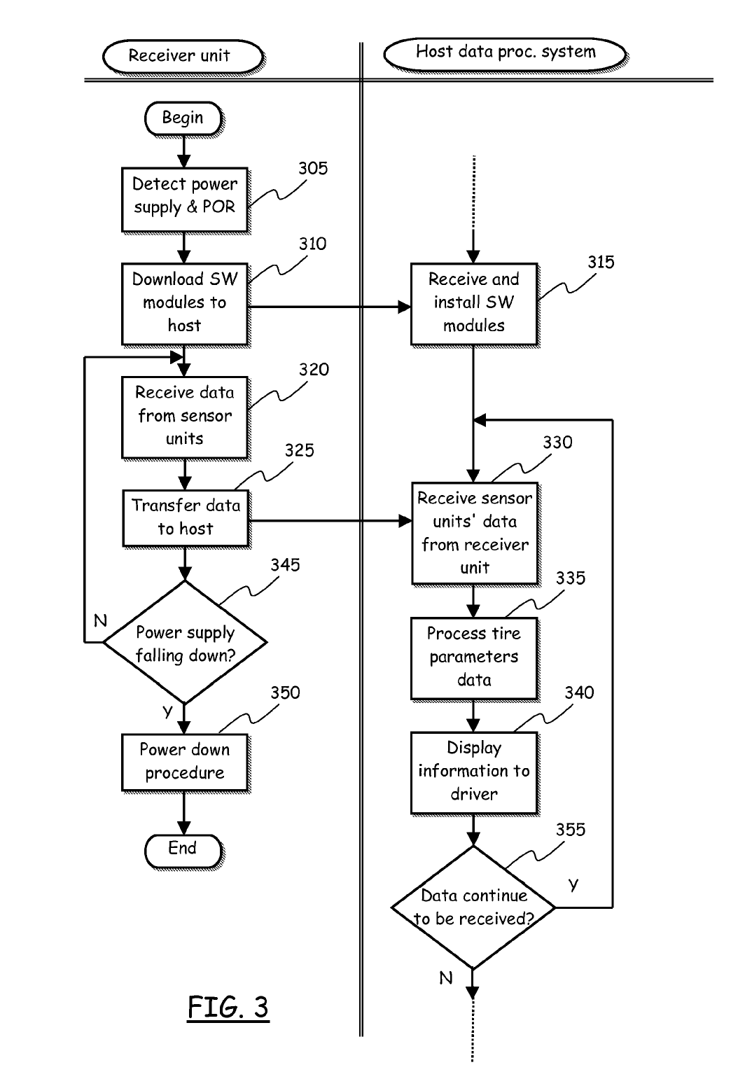

As schematically shown in the simplified action flow of FIG. 3, once the receiver unit 115 is connected to the vehicle's data processing system 140 by plugging the USB connector 125 in the USB connection socket 130 present on the vehicle's dashboard 135, the receiver unit 115 is powered by the USB voltage supplied via the vehicle's data processing system 140; the power management unit 260 detects the presence of the USB voltage and triggers a Power-On Reset (POR) procedure of the receiver unit 115 (action 305), which thus starts operating.

The CPU 215 causes the software modules stored in the data memory 235 to be uploaded to the vehicle's data processing system 140 (action 310). This activity may possibly be subjected to, and triggered by, a deliberate command of the user, for example inputted through a pushbutton provided in the user interface 265 of the receiver unit 115. The upload of the software modules stored in the data memory 235 to the vehicle's data processing system 140 may be triggered by the user, for example, by using pushbuttons, provided on the vehicle's dashboard, or on the steering wheel, external to receiver unit 115 (in the same way as in the case of a music file download from an MP3 music player plugged into the USB socket 130). As soon as the proper software modules to be downloaded are identified by the CPU 215 of the receiver unit 115, a data communication link between the CPU 215 and the CPU 285 of the vehicle's data processing system 140 is established. The download of the software modules to the vehicle's data processing system 140 is then enabled by the user. When, after the receiver unit 115 is plugged in the USB socket 130, the operating system of the vehicle's data processing system 140 may prompt on the vehicle's display 145 a label identifying the receiver unit 115 (as in a conventional “plug-and-play” procedure); at that time, the identification of the proper software modules to be uploaded to the vehicle's data processing system 140 is completed, and the vehicle's data processing system 140 is ready for the software download and installation.

The USB controller 245 of the receiver unit 115 supervises the process of upload of the software modules to the vehicle's data processing system over the USB.

The vehicle's data processing system 140 receives, stores and installs the downloaded software modules (action 315); the vehicle's data processing system 140 now is ready to communicate with the receiver unit 115 using the proper communication protocol, in order to receive therefrom the raw data that are transmitted by the tires' sensor units, and to process and interpret them.

After this set-up phase, the receiver unit 115 listens for transmission from the tires' sensor units; when a sensor unit transmits information on sensed parameters, for example in the form of analog signals, the signals are received by the receiver unit 115 (action 320). In particular, the signal are received by the antenna 210 and conveyed to the RF section 205, which selects the frequency carrier. The RF section 205, which includes an RF band-pass pre-filter and a low noise amplifier, defines the receiver band, amplifies the carrier signal and down-converts the frequency carrier to an Intermediate Frequency (IF) level (by means of a local oscillator). Having selected the desired signal, i.e. the signal from one of the sensor units 105-1, 105-2, 105-3 and 105-4, among all the other signals in the air, demodulation is necessary to separate the information signal from the carrier. Hence, the signal is fed to a demodulator—of any possible kind and technology, for example, albeit not limitatively, Quadrature Mixer technique, PLL discriminator, Quadrature Frequency Discriminator, AM (Amplitude Modulation) envelope detector, AM coherent detector, etc.—and the resulting demodulated signal, containing the data related to the tire's operating parameters measured by the sensor unit, is converted into digital. The digitally-converted data, possibly buffered in the buffers 225, are then transferred to the vehicle's data processing system 140 (action 325). It is pointed out that, instead of analog signal modulation, a digital modulation technique may be employed (e.g. Amplitude Shift Keying—ASK—, Frequency Shift Keying—FSK—, Phase Shift Keying—PSK—, Differential PSK, M-ary FSK, Quadrature PSK—QPSK—, Offset QPSK, π/4 QPSK, Quadrature Amplitude Modulation—QAM—, etc.)

The vehicle's data processing system 140 receives the data from the receiver unit 115 (action 330). The vehicle's data processing system 140 then processes the received data (action 335), and, if necessary, displays information to the vehicle driver, e.g. on the vehicle's display device 135 (action 340). Processing the data received from the receiver unit 115 may for example involve interpreting the received data to derive tires' pressure and/or temperature values, and/or other tires' operating parameters, displaying the current tires' pressure and/or temperature values on the vehicle's display device 145, comparing the current tires' pressure and/or temperature values with predetermined threshold values, and issuing visual and/or audio alerts to the vehicle driver in case the current values fall outside predetermined safety margins. The complexity of the data processing may depend on the nature of the tires' operating parameters.

As long as data are received from the receiver unit 115, the vehicle's data processing system 140 continues to process them; when no more data are received, the data processing stops (action 355, exit branch N).

These actions are repeated essentially until the receiver unit 115 is kept plugged into the USB socket 130; when the receiver unit 115 is unplugged from the USB socket 130, the power management unit 260 detects a power supply failure, and starts a power-down procedure (actions 345, exit branch Y, and 350).

Where provided, visual indicators (LEDs) of the user interface 265 of the receiver unit 115 may be exploited to provide visual alerts to the vehicle's driver, in addition or in alternative to the indications provided by the vehicle's data processing system 140 on the vehicle's display device 145 or through the vehicle's stereo system, like for example alarms for abnormal operating conditions of the tires, and/or the absence of a communication link with one or more of the tires' sensor units (which may for example be due to the discharge of the sensor units' battery, or to a failure thereof).

Thanks to the fact that the receiver unit 115 is also capable of operating as a USB hub or bridge, while the receiver unit 115 is plugged into the vehicle's USB socket 130, the user may plug into the USB socket 250 of the receiver unit 115 other USB peripheral devices, like for example an MP3 reader. The receiver unit's CPU 215, through the USB controllers 245 and 253, manages the transparent flow of data from the vehicle's data processing system 140 to the USB peripheral device plugged into the USB socket 250. The CPU 215 similarly manages congestion avoidance policies, adapted to avoid possible congestion of the bus 240 which is shared for transferring tire sensor units' data from the receiver unit 115 to the vehicle's data processing system 140, and for the exchange of data between the vehicle's data processing system 140 and the USB peripheral device plugged into the USB socket 250.

The receiver unit 115 may store, in the data memory 235, two or more software packages, organized for example in a software repository, specific for different types of sensor units that may be installed on the vehicle's tires. The receiver unit 115 may for example be adapted to identify the type of sensor units that are installed on the vehicle's tires, based on the data received therefrom, and to select in the software repository the appropriate software package to be downloaded to the vehicle's data processing system 140. Another possibility could be that the vehicle's display 145 prompts to the user a list of the software packages available in the (data memory 235 of the) receiver unit 115: the user, e.g. the vehicle's driver, knowing the sensor units manufacturer name, will select the most appropriate software package (in the same way as when he/she selects a music file to be downloaded from an MP3 music player plugged into the USB socket 130). It is also possible that the receiver unit 115 inquiries the sensor units 105-1, 105-2, 105-3 and 105-4 to obtain therefrom an indication of the sensors' type.

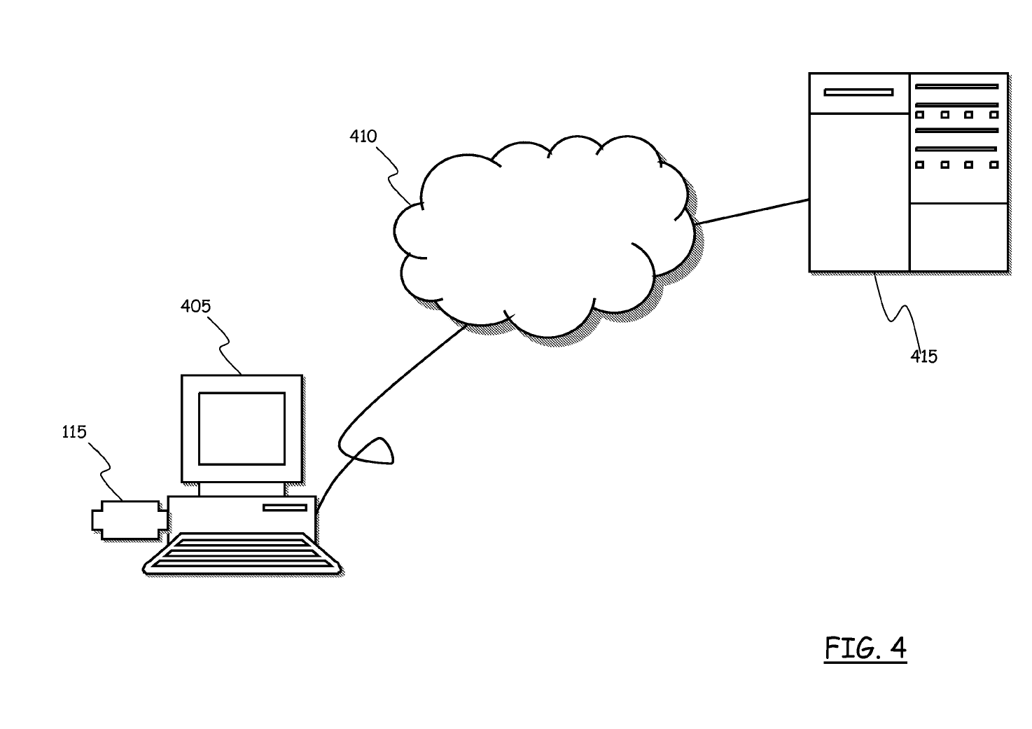

The software to be downloaded to the vehicle's data processing system 140 may be pre-loaded in the receiver unit 115 by the manufacturer. The software in the repository (data memory 235) of the receiver unit 115 may be upgraded and/or enriched with new software packages by downloading new software releases, or additional software packages for new types of sensor units, stored on a memory card, by inserting it into the memory card interface 270 of the receiver unit 115. As pictorially shown in FIG. 4, the software repository of the receiver unit 115 may also be upgraded and/or enriched by downloading new software releases, or additional software packages for new types of sensor units, for example from a PC 405, to which the receiver unit can be connected through a PC USB port. The PC 405 may be connected to a data network 410, such as the Internet, and be capable of downloading the software packages for the receiver unit 115 from a server 415, for example of the manufacturer of the TMPS. The upgrade of the software repository of the receiver unit 115 may be conditioned to a specific command by the user, for example entered through one or more of the pushbuttons of the receiver unit 115; an interrupt service routine of the receiver unit 115 firmware will thus be started by the CPU 215, to accomplish the operations necessary for the downloading and storing in the data memory 235 of the new software. In a similar way, also the firmware of the receiver unit 115 may be upgraded, downloading an upgraded firmware version and storing it into the internal memory 230.

The provision on the receiver unit 115 of input devices like biometric sensors, such as the fingerprint sensor 280, allows the receiver unit 115 to retrieve, for example from its internal memory 230, user-related settings (for example, specific settings for the vehicle's drive parameters, related to the preferences or drive habits of the vehicle's habitual driver or of the vehicle's owner), previously stored in the receiver unit 115. These user-specific data may as well be transferred to the vehicle's data processing system 140, which can thus adapt its functions (for example, the safety margins for the tires' operating parameters may be tuned according to the driving style of the driver); moreover it could be envisaged that the vehicle's data processing system 140 can cause (by interacting with an active suspension system of the vehicle) the proper, customized set up the vehicle' suspensions according to the driving style of the driver.

Exploiting wireless communication interfaces included in the RF section 205, like a Wi-Fi or a Wimax interface, the receiver unit 115 may be able to transmit data related to the tires' conditions, as well as to interact with communication network infrastructures deployed along the roads, for example the motorways. For example, this functionality may be exploited to communicate to a toll payment system of a motorway managing company the number of axes of the vehicle, in order to allow the toll payment system establish the proper toll. Also, parameters like the condition of the road (wet, dry, presence of ice or snow, etc.) might be communicated to other, following vehicles to allow drivers adapt their driving conduct in advance.

The receiver unit according to the described invention embodiments does not pose problems of installation on the vehicles, because it can be relatively small in size, thanks to the fact that it does not need to be equipped with display devices and man/machine interfaces, apart from possible LEDs and a few pushbuttons. The receiver unit does not need any specific wiring for the connection to the vehicle's electrical system, because it is directly supplied through the USB socket 130.

Thanks to the fact that the tasks that the receiver unit according to the described invention embodiments has to perform are relatively limited, it can have limited processing power, and thus its power consumption may be relatively low. Thus, the receiver unit may be battery-operated, through an internal battery, and it may even be totally passive, provided that the standard interface provided on the vehicle is of a type supplying power to peripheral devices connected thereto.

Exploiting the vehicle's data processing system as a host for performing the heavier tasks from the processing viewpoint and the visual/audio display devices already integrated in the vehicle allows simplifying the structure of the receiver unit, reducing its power consumption, and avoids that the impact of the TMPS receiver unit on the aesthetic of the vehicle cabin.

The present invention has been here described considering some possible embodiments thereof. Those skilled in the art will readily recognize that several modifications to the described embodiments are possible, as well as other embodiments, all falling within the scope of the appended claims.

For example, although described in connection with tires' sensors, the present invention may be more generally applicable to other types of vehicles' sensors systems, associated with other vehicles' components.

1-13. (canceled)

14. A device comprising:
a wireless receiver unit capable of being adapted to receive signals from at least one sensor mounted on a vehicle, wherein the signals received from the at least one sensor carry data related to operating parameters of at least one vehicle's component detected by the at least one sensor; and
an interface capable of being adapted to coupling of the device to a peripherals connection port of a vehicle's data processing system integrated in the vehicle, said peripheral connection port being accessible to users within a vehicle's cabin for connection of peripheral type electronic devices,
wherein the device, when coupled to the peripherals connection port of the vehicle's data processing system, is capable of transferring thereto data related to vehicle's operating parameters detected by the at least one sensor, and enabling the vehicle's data processing system to process the transferred data for the interpretation of the operating parameters.

15. The device of claim 14, comprising a power supply unit capable of being adapted to exploit a power supply provided by the vehicle's data processing system through said peripherals connection port for generating a power supply for the operation of the device.

16. The device of claim 14, comprising a repository of at least one software package capable of being adapted to be installed on and executed by the vehicle's data processing system for processing of the data related to the vehicle's operating parameters detected by the at least one sensor, wherein the device is capable of being adapted to upload said at least one software package to the vehicle's data processing system when coupled to the peripherals connection port thereof.

17. The device of claim 16, wherein said repository is capable of being adapted to store a library of software packages capable of being adapted to be installed on and executed by the vehicle's data processing system for said processing of data related to the vehicle's operating parameters detected by the at least one sensor, each software package of said library corresponding to a respective type of sensor.

18. The device of claim 17, comprising a processing unit capable of being adapted to identify in said library a software package corresponding to a specific type of sensor mounted on the vehicle, and to upload to the vehicle's data processing system an identified software package.

19. The device of claim 16, comprising a processing unit capable of being adapted to download said at least one software package from a software storage and to store said software package in said repository.

20. The device of claim 19, wherein said software package storage comprises a memory card, and wherein the device comprises a memory card connection interface capable of being adapted to plugging of the memory card wherein said at least one software package to be downloaded is stored.

21. The device of claim 19, wherein said processing unit is capable of being adapted to download said at least one software package from said software package storage by connection of said interface to a peripheral connection port of the software package storage.

22. The device of claim 14, further comprising a connection interface having a peripherals connection port replicating the peripherals connection port of the vehicle's data processing system, wherein the device, when coupled to the peripherals connection port of the vehicle's data processing system, is capable of being adapted to operate as a bridge between a peripheral device connected to said connection port of the connection interface and the vehicle's data processing system.

23. The device of claim 14, wherein said interface comprises a universal serial bus interface or a firewire interface capable of being adapted to the coupling of the device to a universal serial bus port or a firewire port of the vehicle's data processing system.

24. The device of claim 14, wherein said at least one sensor comprises a tire's operating parameters sensor associated with at least one of a vehicle's tires.

25. The device of claim 24, wherein said data related to a vehicle's operating parameters detected by the at least one sensor comprises one or more of a tire's inflating pressure, a tire's temperature, a tire's number of revolutions, a tire's friction coefficient, exerted forces at a tire-road interface, a tire's contact patch area length, a tire's slip angle, a tire's aquaplaning conditions, road conditions and a tire's tread band wear.

26. A vehicle's components operating conditions monitoring system comprising:
at least one sensor unit capable of being adapted to associate with a vehicle's component, the at least one sensor unit comprising at least one sensor capable of being adapted to detect a vehicle's component operating parameters, and a wireless transmitter capable of being adapted to wirelessly transmit signals carrying data related to the vehicle's component operating parameters detected by the at least one sensor; and
a wireless receiver unit capable of being adapted to receive said signals from the at least one sensor unit, wherein said wireless receiver unit is realized by a device according to claim 14.
